(19) United States
(12) Patent Application Publication
(10) Pub. No.: US 2016/0013498 A1
(43) Pub. Date: Jan. 14, 2016

(54) Instant power (I.P. PACK)

(71) Applicant: Demetrius Herring, Stone Mountain, GA (US)

(72) Inventor: Demetrius Herring, Stone Mountain, GA (US)

(73) Assignee: DEMETRIUS HERRING, STONE MOUNTAIN, GA (US)

(21) Appl. No.: 14/121,701

(22) Filed: Oct. 9, 2014

Related U.S. Application Data
(60) Provisional application No. 61/961,480, filed on Oct. 16, 2013.

(51) Int. Cl. H01M 6/06

(52) U.S. Cl. CPC H01M 6/06; H01M 2220/30

(57) ABSTRACT

This invention relates to the batteries used to power cellphones of particular brands and models. This particular type of alkaline disposable battery will be the first created with compatibility to supplement not replace manufactured batteries but merely to provide owners of mobile phone devices the power to re-power their device without waiting until their phone recharges, the battery will be made of alkaline and possible make up of Lithium-ion that comes equipped with power when you purchase it off the shelves of your local convenient stores Walmart, Lowes, Home Depot etc., it will work just like double AA, alkaline C or D batteries you can buy off shelves created by major battery giants like Duracell, Energizer, Eveready etc., it will be manufactured with the compatibility to fit whatever brand mobile device that is created ruling out the need for charging in emergency situations.

### BACKGROUND OF THE INVENTION

The photo is of a designed disposable battery made of alkaline to provide instant power to any compatible mobile device produced by Samsung giant, compatible with Galaxy devices for now.

### HISTORY OF ALKALINE BATTERIES

(1) The study of electricity required the ability to store the object of study. As a result, batteries developed initially as a way of creating electricity both for study and as part of other experiments. With the advent of the industrial age, cheaper, more powerful batteries became necessary. The alkaline battery is currently one of the most powerful disposable batteries available.

(2 Alkaline batteries are one of several types of “dry cell” designs which use a solid electrode surrounded by a chemical paste to generate electricity. These typically come in 1.5-volt, 6-volt, and 9-volt designs. Alkaline cells were introduced into the marketplace in the 1960s. Alkaline batteries are clearly superior to the older zinc-carbon type, but are not on par with some newer battery designs.

(3) All alkaline batteries are made from chemicals that aren't toxic and you can recycle them at certain recycling facilities. A concern with all types of batteries is corrosion and them leaking battery acid once they ar e expired. Alkaline batteries tend to leak less than other comparable batteries, such as zinc-carbon batteries. The zinc-carbon battery leaks more because the lining of the battery deteriorates faster than those in alkaline batteries

### SUMMARY

The main purpose of this invention is to prevent or curb the need to recharge your phone in emergency situations and/or make it very convenient to use your phone by keeping an alkaline produced compatible battery that will be created with built in power made of alkaline that you can use to give your phone the power it needs whenever or wherever your factory built battery runs out, providing your mobile phone with instant power, not having to wait for recharge, very convenient for businessmen, hikers, bikers, campers everyone that carries a mobile phone.

### DESCRIPTION OF DRAWING

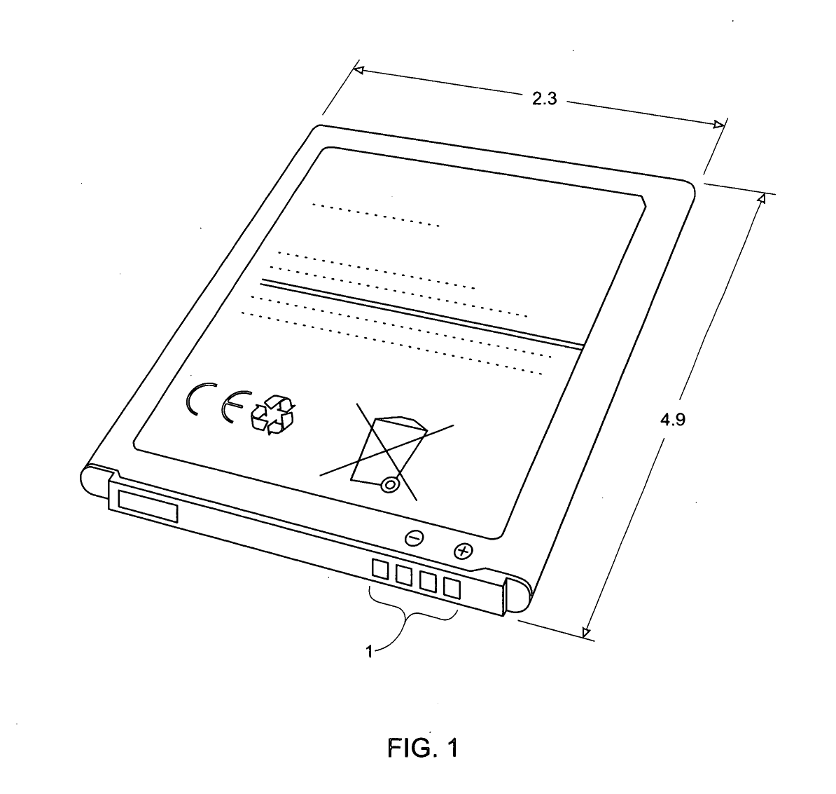

The drawing (FIG. 1) on page 4 is of a designed disposable battery made of alkaline to provide instant power to any compatible mobile device produced by Samsung.

What is claimed:

1. A mobile phone alkaline disposable battery with possible lithium ion equipped.

2. A mobile phone disposable battery produced to provide your mobile device with instant power.
